(19) United States
(12) Patent Application Publication
(10) Pub. No.: US 2015/0045084 A1
(43) Pub. Date: Feb. 12, 2015

(54) RADIO COMMUNICATION SYSTEM, BASE STATION, AND COMMUNICATION CONTROL METHOD

(71) Applicant: NTT DOCOMO, INC., Tokyo (JP)

(72) Inventors: Akihito Morimoto, Chiyoda-ku (JP); Nobuhiko Miki, Chiyoda-ku (JP); Daisuke Nishikawa, Chiyoda-ku (JP); Hiroyuki Ishii, Palo Alto, CA (US)

(73) Assignee: NTT DOCOMO, INC., Chiyoda-ku (JP)

(21) Appl. No.: 14/380,597

(22) PCT Filed: Jan. 15, 2013
(86) PCT No.: PCT/JP2013/050527

§ 371 Date: Aug. 22, 2014

(30) Foreign Application Priority Data
Mar. 1, 2012 (JP) 2012-045617

(51) Int. Cl. H04W 52/24

(52) U.S. Cl. CPC H04W 52/242; H04W 52/241
USPC 455/522

(57) ABSTRACT

Downlink reception power from a second base station is adjusted upward using a cell range expansion offset value. Based on the downlink reception power, a connection destination base station for a user device is selected. A parameter for calculating a target uplink reception characteristic at the second base station is set according to the cell range expansion offset value corresponding to the second base station. Based on the parameter, the target uplink reception characteristic of radio waves from the user device is calculated. Uplink transmission power of the user device is controlled so that an uplink reception characteristic of radio waves from the user device approaches the target uplink reception characteristic.

### TECHNICAL FIELD

The present invention relates to radio communication systems, base stations, and communication control methods.

### BACKGROUND ART

Recently, there have been suggested heterogeneous networks (HetNet) in which multiple kinds of base stations (macro base station, pico base station, femto base station, remote radio head, etc.) with varying downlink transmission power (downlink transmission capacities) are placed in a multilayered way (e.g., Patent Document 1). In a heterogeneous network, a configuration is generally used in which a connection destination base station is selected based on downlink reception power at a user device. In the configuration above, compared with a base station with low downlink transmission power (e.g., pico base station), a base station with high downlink transmission power (e.g., macro base station) is more likely to be selected as a connection destination base station for a user device at the stage of cell search or handover. In other words, compared with a cell of a base station with low downlink transmission power (e.g., picocell), a cell of a base station with high downlink transmission power (e.g., macrocell) tends to have wider coverage.

### CITATION LIST

### Patent Document

Patent Document 1: Japanese Unexamined Patent Publication No. 2011-124732

### SUMMARY OF INVENTION

### Technical Problem

In the technology according to Patent Document 1 in which a connection destination base station is selected according to downlink reception power at a user device, there is a possibility that uplink transmission power from the user device to the base station is not set appropriately. Since a user device with a given transmission capacity can transmit uplink signals to multiple kinds of base stations in uplink communication, a base station at which path loss (propagation loss) from a user device to the base station is low (e.g., a base station closer to a user device than other base stations) is suitable for a connection destination base station for uplink communication. However, if a connection destination base station is selected according to downlink reception power at a user device, it is possible that a base station at which path loss is higher than at other base stations is selected as a connection destination. In a case in which a base station at which path loss is high is selected as a connection destination base station, compared with a case in which a base station at which path loss is low is selected as a connection destination base station, uplink transmission power from a user device needs to be set higher. That is, the power of interference from the user device becomes higher. As a result, it is possible that throughput of the overall system decreases.

In light of the situation above, an object of the present invention is to provide, in a radio communication system that includes multiple kinds of radio base stations with varying transmission powers (transmission capacities), a radio communication system, a base station, and a communication control method, each of which is capable of controlling uplink transmission power from a user device appropriately.

### Solution to Problem

A radio communication system according to the present invention includes: base stations including a first base station that forms a first cell and a second base station that forms a second cell that is smaller in area than the first cell; and a user device configured to communicate wirelessly with each of the base stations by transmitting and receiving radio waves. The radio communication system also includes: a downlink reception power adjusting unit configured to adjust downlink reception power from the second base station at the user device upward using a cell range expansion offset value corresponding to the second base station; a connection destination selecting unit configured to select, based on downlink reception power from the first base station and the downlink reception power from the second base station that has been adjusted with the cell range expansion offset value, a connection destination base station for the user device; a target uplink reception characteristic calculating unit configured to calculate a target uplink reception characteristic of radio waves from the user device at at least one base station that is included in the base stations; a parameter setting unit configured to set, according to the cell range expansion offset value corresponding to the second base station, a parameter for calculating a target uplink reception characteristic at the second base station; and a transmission power control unit configured to control uplink transmission power of the user device so that an uplink reception characteristic of radio waves from the user device at the at least one base station approaches the target uplink reception characteristic.

In the present specification, an “uplink reception characteristic” refers to a value related to reception of uplink communication, and it is a concept that includes uplink reception power and an uplink reception quality.

According to the above configuration, a parameter is set in accordance with a cell range expansion offset value, and in accordance with a target uplink reception characteristic that is calculated based on the set parameter, uplink transmission power of a user device is controlled. Therefore, compared with a configuration in which uplink transmission power of a user device is controlled regardless of a cell range expansion value, the transmission power can be controlled more appropriately.

Preferably, the radio communication system includes: a path loss calculating unit configured to calculate path loss between the at least one base station and the user device. The target uplink reception characteristic calculating unit calculates, as the target uplink reception characteristic, target uplink reception power from the user device at the at least one base station based on the following formula:

TURP=P₀−(1−α)·PL

in which TURP represents the target uplink reception power, P₀ represents standard uplink reception power, α represents a path loss correction coefficient, and PL represents the path loss. The parameter setting unit sets, according to the cell range expansion offset value corresponding to the second base station, at least one of the standard uplink reception power and the path loss correction coefficient, each of which is a parameter for calculating target uplink reception power at the second base station. The transmission power control unit controls uplink transmission power of the user device so that uplink reception power from the user device at the at least one base station approaches the target uplink reception power.

According to the above configuration, at least one of the standard uplink reception power and the path loss correction coefficient at the second station is set in accordance with a cell range expansion offset value. Therefore, a difference between target uplink reception power at a first base station from a user device located close to a cell boundary and that at a second base station from the user device located close to the cell boundary is reduced. As a result, a difference in uplink transmission power from the user device at each base station (the first base station, the second base station) is also reduced. Consequently, compared with a configuration in which target uplink reception power is set regardless of a cell range expansion offset value, interference caused by a user device can be curbed.

Preferably, the radio communication system includes: a path loss calculating unit configured to calculate path loss between the at least one base station and the user device; an interference-over-thermal-noise calculating unit configured to calculate an interference over thermal noise at the at least one base station; and a noise figure acquisition unit configured to acquire a noise figure that represents a ratio of input signal quality and output signal quality at the at least one base station. The target uplink reception characteristic calculating unit calculates, as the target uplink reception characteristic, a target uplink reception quality of radio waves from the user device at the at least one base station based on the following formula:

TUSINR=(P₀−(1−α)·PL)/(IoT+NF)

in which TUSINR represents the target uplink reception quality, P₀ represents standard uplink reception power, α represents a path loss correction coefficient, PL represents the path loss, IoT represents the interference over thermal noise, and NF represents the noise figure.

The parameter setting unit sets, for the user device at which downlink reception power from the first base station is equal to the downlink reception power from the second base station that has been adjusted with the cell range expansion offset value, at least one of the standard uplink reception power and the path loss correction coefficient, each of which is a parameter for calculating a target uplink reception quality at the second base station, so that a difference between a target uplink reception quality at the first base station and the target uplink reception quality at the second base station is reduced. The transmission power control unit controls uplink transmission power of the user device so that an uplink reception quality of radio waves from the user device at the at least one base station approaches the target uplink reception quality.

According to the configuration above, uplink transmission power of a user device is controlled based on a target uplink reception quality. Therefore, compared with a configuration in which uplink transmission power of a user device is controlled based on target uplink reception power, the uplink transmission power can be controlled in a manner that takes interference that a base station receives and noises at the base station into consideration.

Preferably, the second base station includes: an interference-over-thermal-noise notifying unit configured to report an interference over thermal noise calculated by the interference-over-thermal-noise calculating unit of the second base station to the first base station. The parameter setting unit of the first base station sets, based on an interference over thermal noise calculated by the interference-over-thermal-noise calculating unit of the first base station and the interference over thermal noise reported by the interference-over-thermal-noise notifying unit of the second base station, at least one of the standard uplink reception power and the path loss correction coefficient at the first base station and at least one of the standard uplink reception power and the path loss correction coefficient at the second base station. The first base station includes: a parameter notifying unit configured to report, to the second base station, the at least one of the standard uplink reception power and the path loss correction coefficient at the second base station that has been set by the parameter setting unit of the first base station.

According to the configuration above, parameters for a first base station and for a second base station are set in accordance with both an interference over thermal noise acquired at the first base station and that reported by the second base station. Therefore, uplink transmission power control based on the parameters is performed more appropriately.

Preferably, the parameter setting unit sets, as the cell range expansion offset value decreases, the standard uplink reception power at the second base station lower to a greater extent than the standard uplink reception power at the first base station.

According to the configuration above, a difference in the target uplink reception powers at the base stations from a user device located at a cell boundary can be even further reduced.

Preferably, the parameter setting unit sets, as the cell range expansion offset value decreases, the path loss correction coefficient at the second base station lower to a greater extent than the path loss correction coefficient at the first base station.

According to the configuration above, a difference in the target uplink reception powers at the base stations from a user device located at a cell boundary can be even further reduced.

Preferably, the parameter setting unit, as the cell range expansion offset value decreases, sets the standard uplink reception power at the second base station lower to a greater extent than the standard uplink reception power at the first base station and sets the path loss correction coefficient at the second base station lower to a greater extent than the path loss correction coefficient at the first base station.

According to the configuration above, a difference in the target uplink reception powers at the base stations from a user device located at a cell boundary can be even further reduced.

A base station according to the present invention is in a radio communication system that includes: base stations including a first base station that forms a first cell and a second base station that forms a second cell that is smaller in area than the first cell; and a user device configured to communicate wirelessly with each of the base stations by transmitting and receiving radio waves. The base station is the first base station in the radio communication system. The base station includes: a downlink reception power adjusting unit configured to adjust downlink reception power from the second base station at the user device upward using a cell range expansion offset value corresponding to the second base station; a connection destination selecting unit configured to select, based on downlink reception power from its own station and the downlink reception power from the second base station that has been adjusted with the cell range expansion offset value, a connection destination base station for the user device; a target uplink reception characteristic calculating unit configured to calculate a target uplink reception characteristic of radio waves from the user device at at least one base station that is included in the base stations; a parameter setting unit configured to set, according to the cell range expansion offset value corresponding to the second base station, a parameter for calculating a target uplink reception characteristic at the second base station; a parameter notifying unit configured to report the parameter set by the parameter setting unit to the second base station; and a transmission power control unit configured to control uplink transmission power of the user device so that, at the at least one base station, an uplink reception characteristic of radio waves from the user device approaches the target uplink reception characteristic.

Preferably, the base station includes: a path loss calculating unit configured to calculate path loss between the at least one base station and the user device. The target uplink reception characteristic calculating unit calculates, as the target uplink reception characteristic, target uplink reception power from the user device at the at least one base station based on the following formula:

TURP=P₀−(1−α)·PL

in which TURP represents the target uplink reception power, P₀ represents standard uplink reception power, α represents a path loss correction coefficient, and PL represents the path loss. The parameter setting unit sets, according to the cell range expansion offset value corresponding to the second base station, at least one of the standard uplink reception power and the path loss correction coefficient, each of which is a parameter for calculating target uplink reception power at the second base station. The transmission power control unit controls uplink transmission power of the user device so that uplink reception power from the user device at the at least one base station approaches the target uplink reception power.

Preferably, the base station includes: a path loss calculating unit configured to calculate path loss between the at least one base station and the user device; an interference-over-thermal-noise calculating unit configured to calculate an interference over thermal noise at the at least one base station; and a noise figure acquisition unit configured to acquire a noise figure that represents a ratio of input signal quality and output signal quality at the at least one base station. The target uplink reception characteristic calculating unit calculates, as the target uplink reception characteristic, a target uplink reception quality of radio waves from the user device at the at least one base station based on the following formula:

TUSINR=(P₀−(1−α)·PL)/(IoT+NF)

in which TUSINR represents the target uplink reception quality, P₀ represents standard uplink reception power, α represents a path loss correction coefficient, PL represents the path loss, IoT represents the interference over thermal noise, and NF represents the noise figure. The parameter setting unit sets, for the user device at which downlink reception power from its own station is equal to the downlink reception power from the second base station that has been adjusted with the cell range expansion offset value, at least one of the standard uplink reception power and the path loss correction coefficient, each of which is a parameter for calculating a target uplink reception quality at the second base station, so that a difference between a target uplink reception quality at its own station and the target uplink reception quality at the second base station is reduced. The transmission power control unit controls uplink transmission power of the user device so that, at the at least one base station, an uplink reception quality of radio waves from the user device approaches the target uplink reception quality.

Preferably, the base station includes: a receiving unit configured to receive an interference over thermal noise at the second base station reported by the second base station. The parameter setting unit of the first base station sets, based on an interference over thermal noise calculated by the interference-over-thermal-noise calculating unit of the first base station and the interference over thermal noise reported by the interference-over-thermal-noise notifying unit of the second base station, at least one of the standard uplink reception power and the path loss correction coefficient at the first base station and at least one of the standard uplink reception power and the path loss correction coefficient at the second base station. The parameter notifying unit reports, to the second base station, the at least one of the standard uplink reception power and the path loss correction coefficient at the second base station that has been set by the parameter setting unit.

A communication control method according to the present invention is for a radio communication system that includes: base stations including a first base station that forms a first cell and a second base station that forms a second cell that is smaller in area than the first cell; and a user device configured to communicate wirelessly with each of the base stations by transmitting and receiving radio waves. The communication control method includes: adjusting downlink reception power from the second base station at the user device upward using a cell range expansion offset value corresponding to the second base station; selecting, based on downlink reception power from the first base station and the downlink reception power from the second base station that has been adjusted with the cell range expansion offset value, a connection destination base station for the user device; calculating a target uplink reception characteristic of radio waves from the user device at at least one base station that is included in the base stations; setting, according to the cell range expansion offset value corresponding to the second base station, a parameter for calculating a target uplink reception characteristic at the second base station; and controlling uplink transmission power of the user device so that, at the at least one base station, an uplink reception characteristic of radio waves from the user device approaches the target uplink reception characteristic.

Preferably, the communication control method includes: calculating path loss between the at least one base station and the user device; in the calculating of the target uplink reception characteristic, as the target uplink reception characteristic, target uplink reception power from the user device at the at least one base station is calculated based on the following formula:

TURP=P₀−(1−α)·PL

in which TURP represents the target uplink reception power, P₀ represents standard uplink reception power, α represents a path loss correction coefficient, and PL represents the path loss; in the setting of the parameter, according to the cell range expansion offset value corresponding to the second base station, at least one of the standard uplink reception power and the path loss correction coefficient, each of which is a parameter for calculating target uplink reception power at the second base station, is set; and in the controlling of the transmission power, uplink transmission power of the user device is controlled so that, at the at least one base station, uplink reception power from the user device approaches the target uplink reception power.

Preferably, the communication control method includes: calculating path loss between the at least one base station and the user device; calculating an interference over thermal noise at the at least one base station; acquiring a noise figure that represents a ratio of input signal quality and output signal quality at the at least one base station; in the calculating of the target uplink reception characteristic, as the target uplink reception characteristic, a target uplink reception quality of radio waves from the user device at the at least one base station is calculated based on the following formula:

TUSINR=(P₀−(1−α)·PL)/(IoT+NF)

in which TUSINR represents the target uplink reception quality, P₀ represents standard uplink reception power, α represents a path loss correction coefficient, PL represents the path loss, IoT represents the interference over thermal noise, and NF represents the noise figure; in the setting of the parameter, for the user device at which downlink reception power from the first base station is equal to the downlink reception power from the second base station that has been adjusted with the cell range expansion offset value, at least one of the standard uplink reception power and the path loss correction coefficient, each of which is a parameter for calculating a target uplink reception quality at the second base station, is set so that a difference between a target uplink reception quality at the first base station and the target uplink reception quality at the second base station is reduced; and in the controlling of the transmission power, uplink transmission power of the user device is controlled so that, at the at least one base station, an uplink reception quality of radio waves from the user device approaches the target uplink reception quality.

### BRIEF DESCRIPTION OF DRAWINGS

FIG. 1 is a block diagram illustrating a radio communication system according to a first embodiment of the present embodiment;

FIG. 2 is a block diagram illustrating a configuration of a user device according to the first embodiment of the present invention;

FIG. 3 is a block diagram illustrating a configuration of a macro base station according to the first embodiment of the present invention;

FIG. 4 is a block diagram illustrating a configuration of a pico base station according to the first embodiment of the present invention;

FIG. 5 is a diagram illustrating a state of downlink communication in a heterogeneous network according to the first embodiment of the present invention;

FIG. 6 is a diagram illustrating a state of uplink communication in the heterogeneous network;

FIG. 7 is a diagram illustrating a state of downlink communication and that of uplink communication together;

FIG. 8 is a diagram illustrating a change in a range of the picocell before and after downlink reception power is adjusted;

FIG. 9 is a diagram illustrating details of the adjustment of downlink reception power from a pico base station 200;

FIG. 10 is a diagram illustrating control of target uplink reception power with changes in path loss;

FIG. 11 is a diagram illustrating a problem in the control of the target uplink reception power in the heterogeneous network;

FIG. 12 is a diagram illustrating control of standard uplink reception power when an offset value is low;

FIG. 13 is a diagram illustrating the control of the standard uplink reception power when the offset value is high;

FIG. 14 is a diagram illustrating control of a path loss correction coefficient when the offset value is low;

FIG. 15 is a diagram illustrating the control of the path loss correction coefficient when the offset value is high;

FIG. 16 is a block diagram illustrating a configuration of a macro base station according to a third embodiment of the present invention;

FIG. 17 is a block diagram illustrating a configuration of a pico base station according to the third embodiment of the present invention;

FIG. 18 is a diagram illustrating control of standard uplink reception power and a path loss correction coefficient according to a modification of the present invention.

### DESCRIPTION OF EMBODIMENTS

### First Embodiment

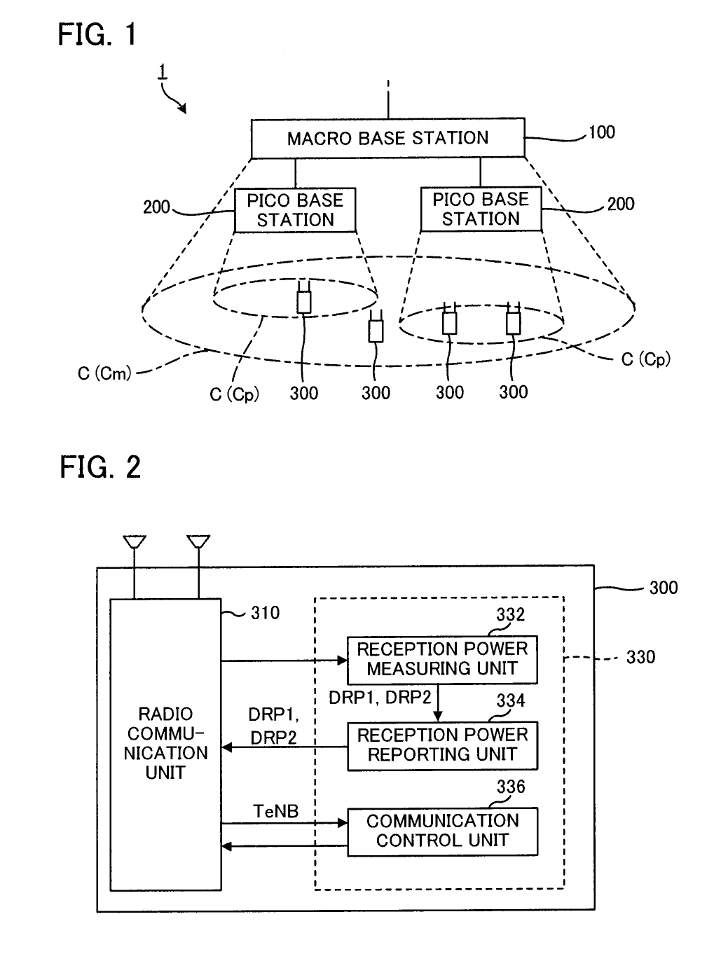

FIG. 1 is a block diagram illustrating a radio communication system 1 according to a first embodiment. The radio communication system 1 includes a macro base station (macro eNodeB (evolved Node B)) 100, a pico base station (pico eNodeB) 200, and a user device 300. Each communication component (the macro base station 100, the pico base station 200, the user device 300, etc.) in the radio communication system 1 performs radio communication in accordance with a given radio access technology such as Long Term Evolution (LTE). The present embodiment describes an example in which the radio communication system 1 operates in accordance with LTE; however, it is not intended to limit the technical scope of the present invention. The present invention can be used with other radio access technologies with necessary design modifications.

The macro base station 100 and the pico base station 200 are connected to each other by wired or wireless connection. The macro base station 100 forms a macrocell Cm around it, and the pico base station 200 forms a picocell Cp around it. The picocell Cp is a cell C that is formed in the macrocell Cm formed by the macro base station 100 connected to the pico base station 200 that forms the picocell Cp. There can be multiple picocells Cp in a single macrocell Cm.

Each base station (the macro base station 100, the pico base station 200) can communicate wirelessly with a user device (user equipment, UE) 300 present in the cell C of its own station. In other words, a user device 300 in a cell C (the macrocell Cm or the picocell Cp) can communicate wirelessly with a base station (the macro base station 100, the pico base station 200) corresponding to the cell.

Since the macro base station 100 has higher radio transmission capacity (maximum transmission power, average transmission power, etc.) than the pico base station 200, the macro base station 100 can communicate wirelessly with the user device 300 located at a greater distance. That is, the macrocell Cm has an area greater than the picocell Cp. For example, the macrocell Cm has an area with a radius of several hundred meters to dozens of kilometers, and the picocell Cp has an area with a radius of several meters to dozens of meters.

As can be understood from the description above, the macro base station 100 and the pico base station 200 within the radio communication system 1 constitute a heterogeneous network (HetNet) in which multiple kinds of base stations with varying transmission powers (transmission capacities) are placed in a multilayered way (refer to 3rd Generation Partnership Project; Technical Specification Group Radio Access Network; Evolved Universal Terrestrial Radio Access (E-UTRA); Further advancements for E-UTRA physical layer aspects (Release 9); 3GPP TR 36.814 V9.0.0 (2010-03); Section 9A, Heterogeneous Deployments).

A scheme for radio data transmission between each of the base stations (the macro base station 100, the pico base station 200) and the user device 300 can be freely chosen. For instance, OFDMA (Orthogonal Frequency Division Multiple Access) can be used for the downlink transmission, and SC-FDMA (Single-Carrier Frequency Division Multiple Access) can be used for the uplink transmission.

FIG. 2 is a block diagram illustrating a configuration of the user device 300 according to the first embodiment. The user device 300 includes a radio communication unit 310 and a control unit 330. An output device to output voice and video and an input device to receive instructions from a user are omitted in the figure for the sake of convenience.

The radio communication unit 310 is a component configured to perform radio communication with each of the base stations (the macro base station 100, the pico base station 200). The radio communication unit 310 includes a transceiver antenna, a receiving circuit configured to receive downlink radio signals from the base stations and to convert the downlink radio signals into electrical signals so as to provide the electrical signals to the control unit 330, and a transmitting circuit configured to convert the electrical signals, such as voice signals, provided by the control unit 330 into uplink radio signals so as to transmit the uplink radio signals.

The control unit 330, as its components, includes a reception power measuring unit 332, a reception power reporting unit 334, and a communication control unit 336. The reception power measuring unit 332 measures reception power DRP1 of downlink radio signals received from the macro base station 100 and reception power DRP2 of downlink radio signals received from the pico base station 200 so as to provide the reception power DRP1 and the reception power DRP2 to the reception power reporting unit 334. The reception power reporting unit 334 reports, through the radio communication unit 310, the provided reception power DRP1 and the reception power DRP2 to the base station to which the user device 300 is wirelessly connected. The communication control unit 336 selects a connection destination base station based on connection destination base station information TeNB received from the connected base station so as to perform radio communication.

The control unit 330 and the components included in the control unit 330, the reception power measuring unit 332, the reception power reporting unit 334, and the communication control unit 336, are a functional block performed by a central processing unit (CPU), which is in the user device 300 (not shown in the figure), executing a computer program and functioning in accordance with the computer program, the computer program being stored in a storing unit (not shown in the figure).

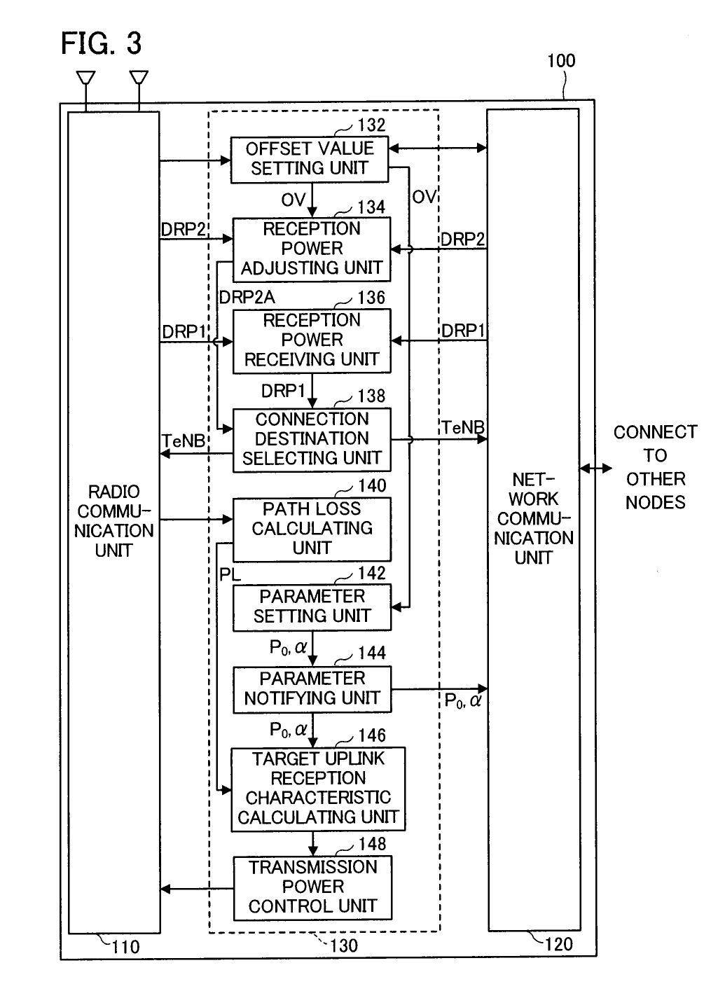

FIG. 3 is a block diagram illustrating a configuration of the macro base station 100 according to the first embodiment. The macro base station 100 includes a radio communication unit 110, a network communication unit 120, and a control unit 130.

The radio communication unit 110 is a component configured to perform radio communication with the user device 300. The radio communication unit 110 includes a transceiver antenna, a receiving circuit configured to receive uplink radio signals from the user device 300 so as to convert the uplink radio signals into electrical signals, and a transmitting circuit configured to convert the electrical signals, such as voice signals, provided by the control unit 130 into downlink radio signals so as to transmit the downlink radio signals.

The network communication unit 120 is a component configured to perform communication with other base stations (another macro base station 100, the pico base station 200). The network communication unit 120 transmits and receives electrical signals to and from another base station. It is understood that when the macro base station 100 is to communicate with other base stations wirelessly, a configuration can be used in which the radio communication unit 110 also functions as the network communication unit 120.

The control unit 130 includes an offset value setting unit 132, a reception power adjusting unit 134, a reception power receiving unit 136, a connection destination selecting unit 138, a path loss calculating unit 140, a parameter setting unit 142, a parameter notifying unit 144, a target uplink reception characteristic calculating unit 146, and a transmission power control unit 148. The control unit 130 and the above-mentioned components included in the control unit 130 are a functional block performed by a CPU, which is in the macro base station 100 (not shown in the figure), executing a computer program and functioning in accordance with the computer program, the computer program being stored in a storing unit (not shown in the figure). Operations of the control unit 130 are described later in detail.

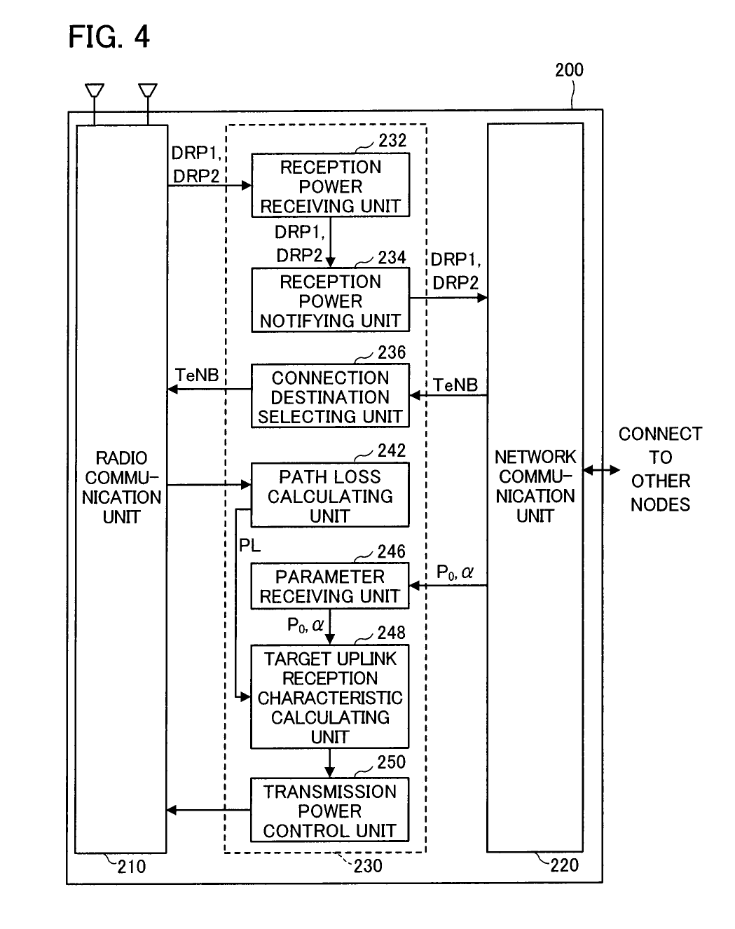

FIG. 4 is a block diagram illustrating a configuration of the pico base station 200 according to the first embodiment. The pico base station 200 includes a radio communication unit 210, a network communication unit 220, and a control unit 230.

The radio communication unit 210 is a component configured to perform radio communication with the user device 300. The radio communication unit 210 includes a transceiver antenna, a receiving circuit configured to receive uplink radio signals from the user device 300 so as to convert the uplink radio signals into electrical signals, and a transmitting circuit configured to convert the electrical signals, such as voice signals, provided by the control unit 230 into downlink radio signals so as to transmit the downlink radio signals.

The network communication unit 220 is a component configured to communicate with the macro base station 100 to which the pico base station 200 itself is connected. The network communication unit 220 transmits and receives electrical signals to and from the macro base station 100. It is understood that when the pico base station 200 is to communicate with the macro base station 100 wirelessly, a configuration can be used in which the radio communication unit 210 functions also as the network communication unit 220.

The pico base station 200 can receive downlink radio signals transmitted by the macro station 100 and transfer the signals to the user device 300. The pico base station 200 can receive uplink radio signals transmitted by the user device 300 and transfer the signals to the macro base station 100.

The control unit 230 includes a reception power receiving unit 232, a reception power notifying unit 234, a connection destination selecting unit 236, a path loss calculating unit 242, a parameter receiving unit 246, a target uplink reception characteristic calculating unit 248, and a transmission power control unit 250. The control unit 230 and the above-mentioned components included in the control unit 230 are a functional block performed by a CPU, which is in the pico base station 200 (not shown in the figure), executing a computer program and functioning in accordance with the computer program, the computer program being stored in a storing unit (not shown in the figure). Operations of the control unit 230 are described later in detail.

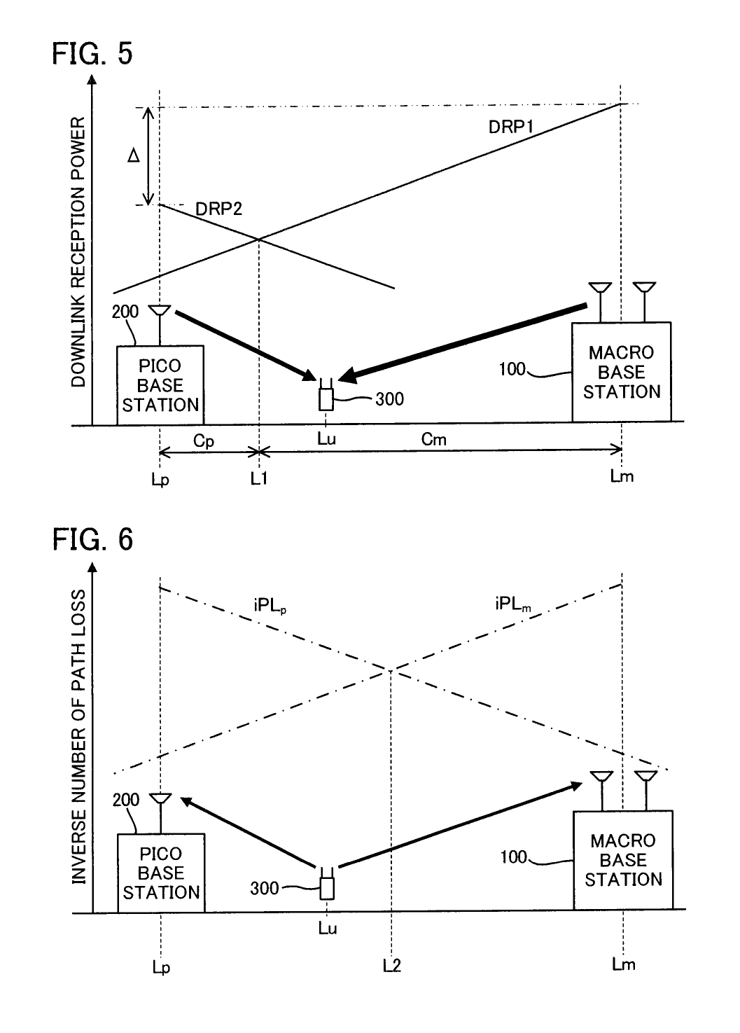

With reference to FIGS. 5 to 7, uplink communication and downlink communication in the heterogeneous network are described. In each figure, a location of the macro base station 100 is referred to as location Lm, that of the pico base station 200 is referred to as location Lp, and that of the user device 300 is referred to as location Lu.

FIG. 5 is a diagram illustrating a state of downlink communication in the heterogeneous network. The user device 300 receives radio waves (downlink radio signals) from each of the base stations (the macro base station 100, the pico base station 200). The horizontal axis represents a location of each device (the macro base station 100, the pico base station 200, and the user device 300), and the vertical axis represents reception power (downlink reception power DRP), expressed in logarithm, of downlink radio signals, at the user device 300, transmitted by the base stations. FIG. 5 shows downlink reception power DRP1 from the macro base station 100 and downlink reception power DRP2 from the pico base station 200. Since radio signals (radio waves) attenuate with distance of propagation, the downlink reception power DRP (DRP1, DRP2) decreases as a distance from a base station (the macro base station 100, the pico base station 200) increases. Hereinafter, the location at which the downlink reception power DRP1 from the macro base station 100 matches the downlink reception power DRP2 from the pico base station 200 is referred to as location L1.

The downlink transmission power (transmission capacity) of the macro base station 100 exceeds that of the pico base station 200 by delta A. In other words, the downlink reception power DRP 1 from the macro base station 100 at the location Lm exceeds the downlink reception power DRP2 from the pico base station 200 at the location Lp by delta Δ. As a result, the macrocell Cm (a range in which the downlink reception power DRP1 from the macro base station 100 exceeds the downlink reception power DRP2 from the pico base station 200) has the radius (Lm to L1) that is greater than the radius (Lp to L1) of the picocell Cp (a range in which the downlink reception power DRP2 from the pico base station 200 exceeds the downlink reception power DRP1 from the macro base station 100). As stated above, if a cell (a connection destination base station) is selected based on reception power DRP, for a user device 300 located in the macrocell Cm, the macro base station 100 is selected as a connection destination, and for a user device 300 located in the picocell Cp, the pico base station 200 is selected as a connection destination.

FIG. 6 is a diagram illustrating a state of uplink communication in the heterogeneous network. The user device 300 transmits radio waves to each of the base stations (the macro base station 100, the pico base station 200). The horizontal axis represents a location of each device, as in FIG. 5. The vertical axis represents the inverse number iPL, expressed in logarithm, of path loss PL from each base station to the user device 300. FIG. 6 shows the inverse number iPLₘ of path loss PLₘ from the macro base station 100 to the user device 300 and the inverse number iPLₚ of path loss PLₚ from the pico base station 200 to the user device 300. Since path loss PL from a base station to the user device 300 increases with a distance (line-of-sight distance) from the base station (the macro base station 100, the pico base station 200) to the user device 300, the inverse number iPL of the path loss PL decreases with the distance (line-of-sight distance) from the base station to the user device 300. The inverse number iPL of the path loss PL from the base station to the user device 300 can be regarded as the path loss from the user device 300 to the base station. Hereinafter, the location at which the inverse number iPLₘ of the path loss PLₘ from the macro base station 100 to the user device 300 matches the inverse number iPLₚ of the path loss PLₚ from the pico base station 200 to the user device 300 is referred to as location L2.

With regard to uplink communication in the heterogeneous network, transmission from a single user device 300 with a given transmission capacity to multiple base stations is under consideration. Therefore, unlike the case with downlink communication, there is no need to consider differences in transmission powers (transmission capacities). That is, in a case in which only uplink communication is under consideration, it is understood that a connection destination base station is preferably selected based on how short the line-of-sight distance from the user device 300 to the base station is (i.e., how low the path loss from the user device 300 to the base station is).

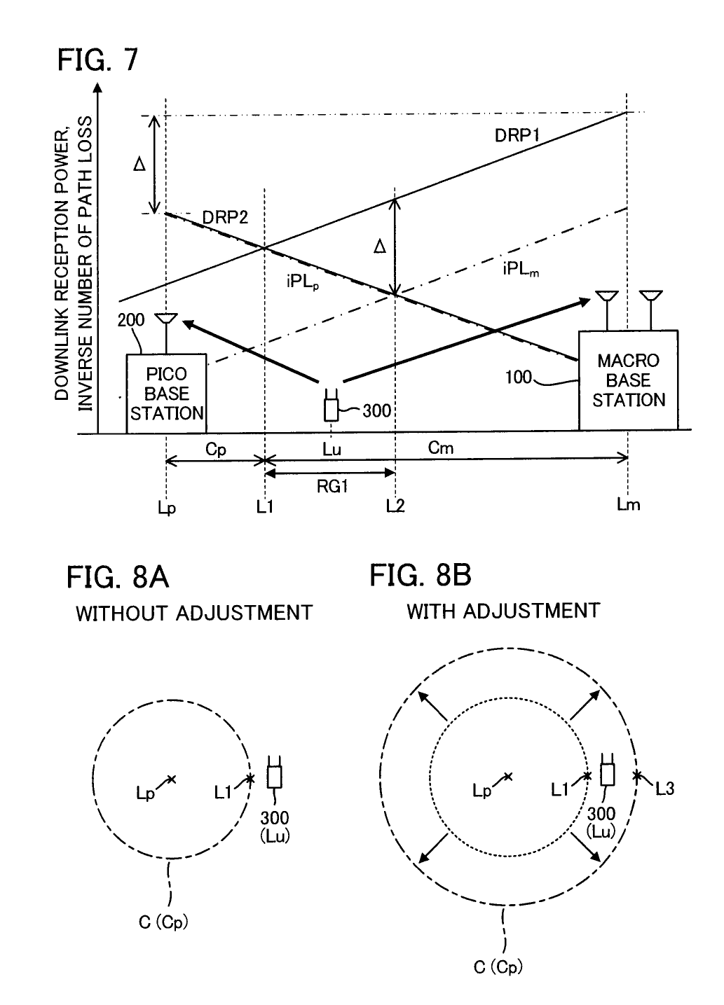

FIG. 7 is a diagram illustrating the state of downlink communication as in FIG. 5 together with that of uplink communication as in FIG. 6. In FIG. 7, the user device 300 is located at the location Lu in the range RG1. In the range RG1 (at the location Lu), the downlink reception power DRP1 from the macro base station 100 exceeds the downlink reception power DRP2 from the pico base station 200. Therefore, for downlink communication, it is understood to be appropriate to select the macro base station 100 as a connection destination base station for the user device 300. On the other hand, in the range RG1 (at the location Lu), the inverse number iPLₚ of the path loss PLₚ from the pico base station 200 to the user device 300 exceeds the inverse number of iPLₘ of the path loss PLₘ from the macro base station 100 to the user device 300 (i.e., the location Lu is closer to the pico base station 200 than to the macro base station 100). Therefore, for uplink communication, it is understood to be appropriate to select the pico base station 200 as a connection destination base station for the user device 300.

As understood from the description above, in a case in which the user device 300 is located in the range RG1 shown in FIG. 7, a connection destination base station appropriate for uplink communication is different from that for downlink communication. Consequently, in a configuration in which a connection destination for the user device 300 is selected based on the downlink reception power DRP, there is a possibility that a connection destination that is not appropriate for uplink communication is selected. More specifically, the user device 300 located in the range RG1 is connected to the macro base station 100 even though the user device 300 is at a greater distance from the macro base station 100 than from the pico base station 200. Therefore, there arises a problem that the user device 300 strongly interferes with the pico base station 200.

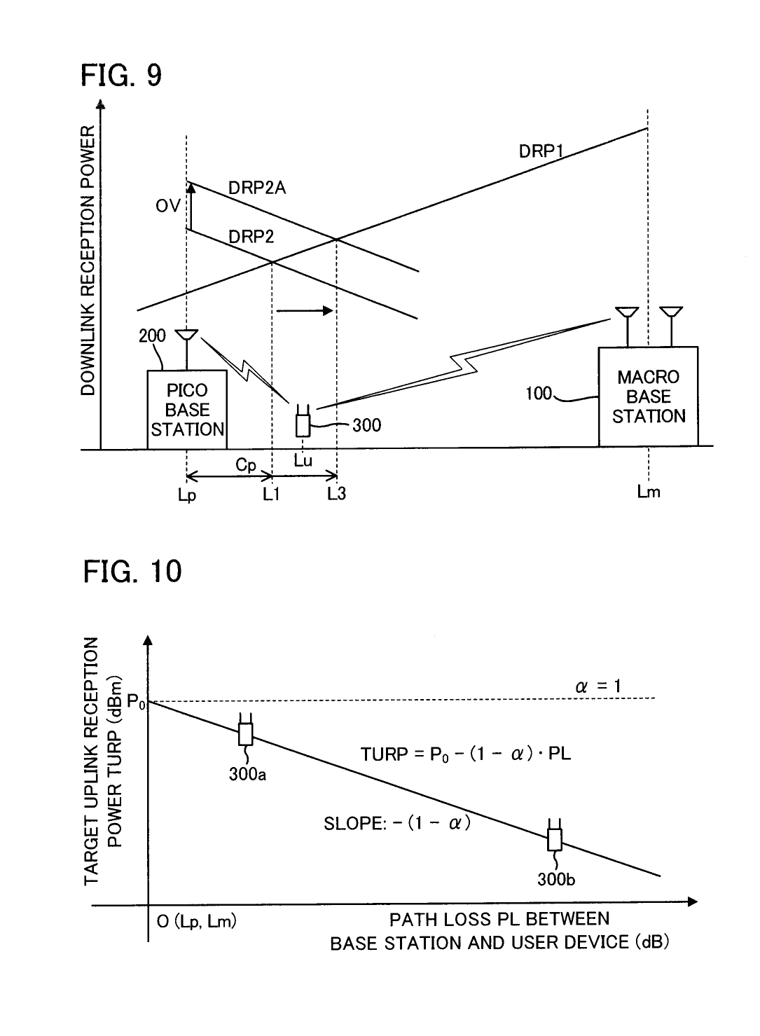

With reference to FIGS. 8 and 9, an adjustment of the downlink reception power DRP is described. As described above, in the heterogeneous network, since transmission power of the macro base station 100 is higher than that of the pico base station 200, the macro base station 100 is likely to be selected as a connection destination for a user device 300. However, concentrated connections from user devices 300 at the macro base station 100 may lead to communication traffic concentration, which then can lead to a decrease in throughput of the overall system. In light of the situation above, the downlink reception power DRP2 from the pico base station 200 is preferably adjusted upward so as to pseudo-expand the range of the picocell Cp (cell range expansion) so that a greater number of user devices 300 be connected to the pico base station 200.

FIG. 8 is a diagram illustrating a change in the range of the picocell Cp before and after adjusting the downlink reception power DRP. Before the downlink reception power DRP2 from the pico base station 200 is adjusted (FIG. 8A), the picocell Cp formed by the pico base station 200, which is located at the location Lp (and is not shown in the figure), does not include the location Lu at which the user device 300 is located. On the other hand, after the downlink reception power DRP2 from the pico base station 200 is adjusted (FIG. 8B), the picocell Cp includes the location Lu at which the user device 300 is located.

FIG. 9 is a diagram illustrating details of the adjustment of the downlink reception power DRP2 from the pico base station 200. As stated above, the user device 300 receives radio waves from each of the macro base station 100 and the pico base station 200. The downlink reception power DRP attenuates as the distance from each base station increases. As in FIGS. 5 and 7, the reception power DRP 1 from the macro base station 100 matches the downlink reception power DRP2 from the pico base station 200 at the location L1. According to the adjustment of the present embodiment, since the downlink reception power DRP2 from the pico base station 200 is adjusted upward with an offset value OV, the reception power DRP1 from the macro base station 100 matches the adjusted reception power DRP2A from the pico base station 200 at the location L3 that is closer to the macro base station 100 than the location L1. In other words, by the adjustment using the offset value OV, the radius of the picocell Cp expands from the distance between the location Lp and the location L1 to the distance between the location Lp and the location L3.

Specific operations of the adjustment are described below. The reception power measuring unit 332 of the user device 300 measures the downlink reception power DRP 1 from the macro base station 100 and the downlink reception power DRP2 from the pico base station 200. The reception power reporting unit 334 of the user device 300 reports, through the radio communication unit 310, the downlink reception power DRP1 and the downlink reception power DRP2 to the base station (the macro base station 100, the pico base station 200) to which the user device 300 is wirelessly connected.

When the user device 300 reports the downlink reception power DRP1 and the downlink reception power DRP2 to the pico base station 200, the reception power receiving unit 232 of the pico base station 200 receives each reception power DRP through the radio communication unit 210, and then the reception power notifying unit 234 reports each reception power DRP to the macro base station 100 through the network communication unit 220.

Upon receiving the downlink reception power DRP2 from the pico base station 200 at the user device 300, the reception power adjusting unit 134 of the macro base station 100 adjusts the downlink reception power DRP2 using an offset value OV provided by the offset value setting unit 132. As a result of the above-described adjustment, the downlink reception power DRP2 becomes the adjusted downlink reception power DRP2A that is increased by the offset value OV. The offset value setting unit 132 can vary the offset value OV for each pico base station 200 according to a traffic load in the network, the radio environment of the pico base station 200, or the like.

The connection destination selecting unit 138 of the macro base station 100 selects, based on the downlink reception power DRP1 from the macro base station 100 provided by the reception power receiving unit 136 and the adjusted downlink reception power DRP2A from the pico base station 200 provided by the reception power adjusting unit 134, a connection destination base station for the user device 300. Connection destination base station information TeNB that indicates the selected base station is reported to the user device 300 through the radio communication unit 110 or the network communication unit 120 (and eventually the pico base station 200). The communication control unit 336 of the user device 300 selects a connection destination base station based on the reported connection destination base station information TeNB.

By the above-described cell range expansion, the size of the picocell Cp increases. Therefore, a greater number of user devices 300 are to be connected to the pico base station 200.

The above-described cell range expansion has a configuration in which the downlink reception power DRP from the pico base station 200 is adjusted when a connection destination cell is selected based on the downlink reception power DRP. When the range of the picocell Cp expands, a user device 300 that is connected to the macro base station 100 even though the user device 300 is closer to the pico base station 200 than to the macro base station 100 (specifically, the user device 300 located in the range RG1 in FIG. 7) is more likely to be connected to the pico base station 200. That is, the above-described cell range expansion is beneficial for uplink communication as well as for downlink communication.

Generally, with regard to uplink communication, as a user device 300 moves farther from a base station (i.e., as the path loss PL from the base station to the user device 300 increases), the uplink transmission power of the user device 300 required to achieve a given target uplink reception power at the base station increases. However, with a configuration in which the uplink transmission power of the user device 300 is increased as the path loss PL increases, there is a problem of increasing interference caused by the user device 300 located at a great distance from the base station (e.g., the user device 300 located at the edge of a cell) that leads to lower throughput of the overall cell.

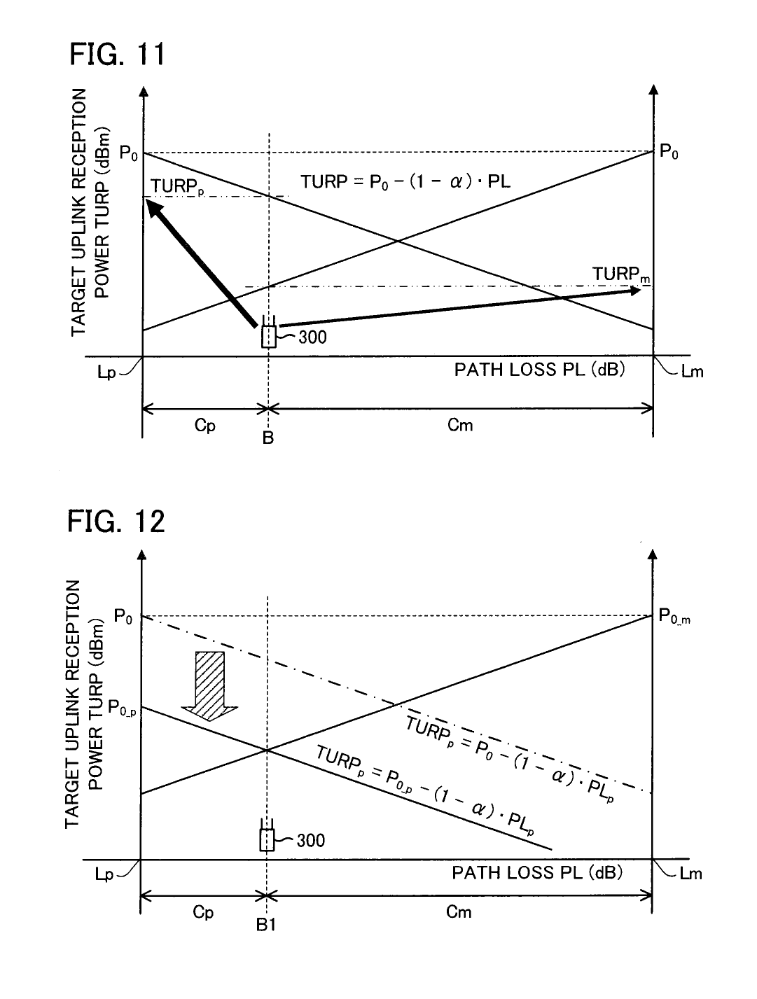

In light of the situation above, as shown FIG. 10, target uplink reception power TURP at a base station (the macro base station 100, the pico base station 200) is preferably lowered as the path loss PL increases. In FIG. 10, the horizontal axis (expressed in logarithm) represents path loss PL from the base station to the user device 300 at the user device 300, and the vertical axis (expressed in logarithm) represents target uplink reception power TURP at the base station.

In FIG. 10, the target uplink reception power TURP is represented as a function (TURP=P₀−(1−α)·PL) that has the path loss PL as a variable, with a slope −(1−α) (where a is a real number between 0 and 1), and an intercept P₀. When α=1, the target uplink reception power TURP is not controlled according to the path loss PL (TURP is always equal to P₀). The origin O is the point at which the path loss PL from the base station to the user device 300 is equal to 0; that is, the location (Lp, Lm) of the base station (the macro base station 100, the pico base station 200). Ways to set the path loss correction coefficient α and the standard uplink reception power P₀ are described later.

Since the function described above has a negative slope, as the path loss PL increases (i.e., as the user device 300 moves farther from the base station), the target uplink reception power TURP decreases. For example, since the path loss PL at the user device 300b located at the edge of a cell is greater than that at the user device 300a located close to the base station, the target uplink reception power TURP for the user device 300b is set lower than that for the user device 300a. In the above-described configuration, an increase in the uplink transmission power of the user device 300 due to an increase in the path loss PL can be curbed.

The control of the target uplink reception power TURP (i.e., the control of the uplink transmission power of the user device 300) as described above by referring to FIG. 10, when used with the heterogeneous network, can lead to a problem as illustrated in FIG. 11. FIG. 11 is a diagram illustrating the target uplink reception power TURPₚ at the pico base station 200 and the target uplink reception power TURPₘ at the macro base station 100 that are calculated based on the control as described in FIG. 10. In FIG. 11, the pico base station 200 is located at the location Lp and the macro base station 100 is located at the location Lm.

The boundary between the picocell Cp and the macrocell Cm is referred to as the cell boundary B. The user device 300 is assumed to be located close to the cell boundary B. When the user device 300 close to the cell boundary B is to connect wirelessly to the macro base station 100, since the path loss PLₘ from the macro base station 100 to the user device 300 is relatively high (the macro base station 100 is farther from the user device 300 than the pico base station 200), the target uplink reception power TURPₘ is maintained relatively low. That is, the uplink transmission power of the user device 300 is maintained relatively low. Therefore, interference that other base station (the pico base station 200) receives from the user device 300 is also relatively low.

On the other hand, when the user device 300 close to the cell boundary B is to connect to the pico base station 200, since the path loss PLₚ from the pico base station 200 to the user device 300 is relatively low (the pico base station 200 is closer to the user device 300 than the macro base station 100), the target uplink reception power TURPₚ is relatively high. That is, the uplink transmission power of the user device 300 is relatively high. Therefore, interference that other base station (the macro base station 100) receives from the user device 300 is also relatively high.

In other words, at the cell boundary B, the difference between the path loss PLₚ from the pico base station 200 to the user device 300 and the path loss PLₘ from the macro base station 100 to the user device 300 is large. Therefore, if the control as described in FIG. 10 is used, the transmission power of the user device 300 differs greatly depending on the connection destination base station.

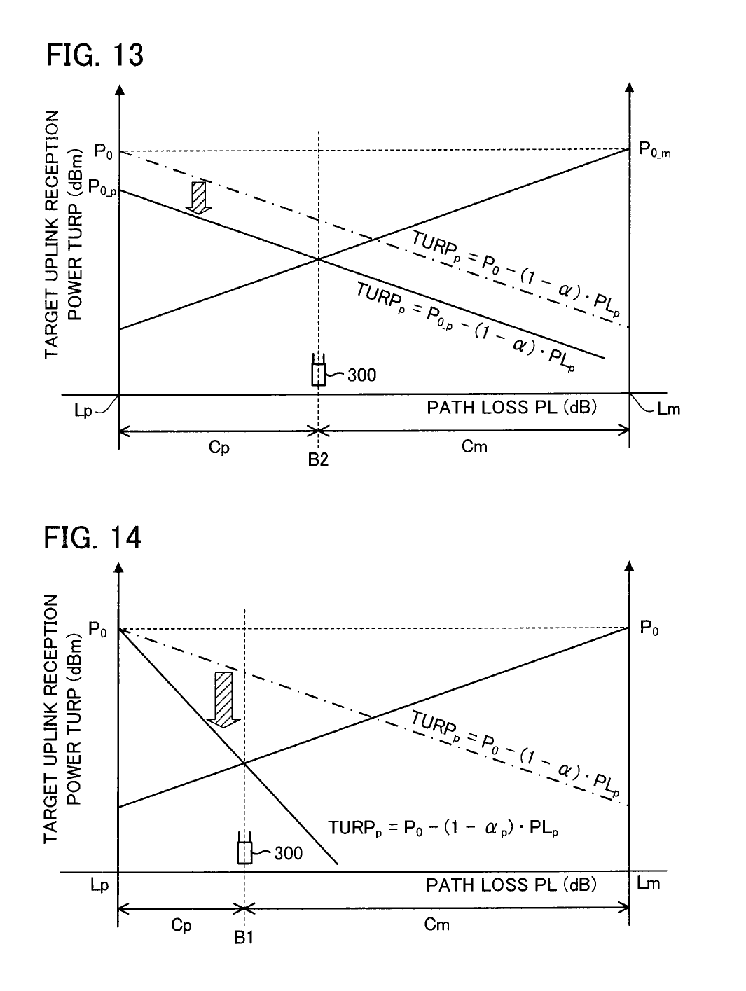

When the cell boundary B is fixed, the path loss PLₚ and the path loss PLₘ at the cell boundary B do not change much. However, with the cell range expansion as described by referring to FIGS. 8 and 9, since the adjustment of the downlink reception power DRP2 from the pico base station 200 using the offset value OV changes the cell boundary B, the path loss PLₚ and the path loss PLₘ at the cell boundary B also change. Specifically, in the case of a low offset value OV, the cell boundary B1 is close to the pico base station 200 (e.g., FIG. 12), and in the case of a high offset value OV, the cell boundary B2 is closer to the macro base station 100 (e.g., FIG. 13) than in the case of a low offset value OV. Consequently, when the offset value OV is low, the difference between the path loss PLₚ and the path loss PLₘ at the cell boundary B1 is large, and when the offset value OV is high, the difference between the path loss PLₚ and the path loss PLₘ at the cell boundary B1 is small.

Taking the above-described situation into consideration, in the present embodiment, the standard uplink reception power P₀, a parameter used to calculate the target uplink reception power TURP at the pico base station 200, is set (changed) according to the offset value OV used for the cell range expansion. With reference to FIGS. 12 and 13, explanation is provided below. In FIGS. 12 and 13, the user device 300 is assumed to be connected wirelessly to the pico base station 200.

FIG. 12 illustrates a case in which the offset value OV is relatively low. The parameter setting unit 142 of the macro base station 100 sets the standard uplink reception power P₀_{_{—}}ₚ according to the offset value OV provided by the offset value setting unit 132. As described above, since the offset value OV is relatively low and the cell boundary B1 is close to the pico base station 200 in FIG. 12, the difference between the path loss PLₚ and the path loss PLₘ at the cell boundary B1 is large. The parameter setting unit 142, therefore, sets the standard uplink reception power P₀_{_{—}}ₚ, so that the difference (P₀_{_{—}}ₘ−P₀_{_{—}}ₚ) between the standard uplink reception power P₀_{_{—}}ₚ, at the pico base station 200 and the standard uplink reception power P₀_{_{—}}ₘ at the macro base station 100 be relatively large.

On the other hand, FIG. 13 illustrates a case in which the offset value OV is relatively high. In FIG. 13, compared with FIG. 12, the cell boundary B2 is close to the macro base station 100, and thus, the difference between the path loss PLₚ and the path loss PLₘ at the cell boundary B2 is small. The parameter setting unit 142, therefore, sets the standard uplink reception power P₀_{_{—}}ₚ, so that the difference (P₀_{_{—}}ₘ−P₀_{_{—}}ₚ) between the standard uplink reception power P₀_{_{—}}ₚ at the pico base station 200 and the standard uplink reception power P₀_{_{—}}ₘ at the macro base station 100 be relatively small.

As described above, as the offset value OV decreases, the parameter setting unit 142 sets the standard uplink reception power P₀_{_{—}}ₚ at the pico base station 200 lower to a greater extent than the standard uplink reception power P₀_{_{—}}ₘ at the macro base station 100. The standard uplink reception power P₀_{_{—}}ₚ set by the parameter setting unit 142 is then provided to the parameter notifying unit 144. Additionally, the path loss correction coefficient α that is not set based on the offset value OV is provided to the parameter notifying unit 144. The parameter notifying unit 144 reports, through the network communication unit 120, the parameters (the standard uplink reception power P₀_{_{—}}ₚ and the path loss correction coefficient α) to the parameter receiving unit 246 of the pico base station 200.

The target uplink reception characteristic calculating unit 248 of the pico base station 200 calculates the target uplink reception power TURPₚ from the user device 300 at the pico base station 200. Specifically, using the path loss PLₚ between the pico base station 200 and the user device 300 that is calculated by the path loss calculating unit 242 and the standard uplink reception power P₀_{_{—}}ₚ and the path loss correction coefficient α that are provided by the parameter receiving unit 246, the target uplink reception characteristic calculating unit 248 calculates the target uplink reception power TURP based on Formula (1) below.

TURPₚ=P₀_{_{—}}ₚ−(1−α)·PLₚ Formula (1)

The transmission power control unit 250 of the pico base station 200, based on the target uplink reception power TURPₚ provided by the target uplink reception characteristic calculating unit 248, controls the uplink transmission power of the user device 300 so that the uplink reception power from the user device 300 approaches the target uplink reception power TURPₚ. For example, when the uplink reception power from the user device 300 is lower than the target uplink reception power TURPₚ, the transmission power control unit 250 commands the user device 300 to increase the transmission power. When the uplink reception power from the user device 300 is higher than the target uplink reception power TURPₚ, the transmission power control unit 250 commands the user device 300 to decrease the transmission power.

With regard to the user device 300 located at the cell boundary B, it is even more preferable if the standard uplink reception power P₀_{_{—}}ₚ set so that the target uplink reception power TURPₚ at the pico base station 200 matches the target uplink reception power TURPₘ at the macro base station 100.

In the above configuration, since the standard uplink reception power P₀ at the pico base station 200 is set according to the offset value OV used for the cell range expansion, the difference between the target uplink reception power TURPₘ at the macro base station 100 from the user device 300 located close to the cell boundary B and the target uplink reception power TURPₚ at the pico base station 200 from the user device 300 located close to the cell boundary B is reduced. As a result, the difference in the uplink transmission powers from the user device 300 to the base stations (the macro base station 100, the pico base station 200) is also reduced. Therefore, compared with a configuration in which the target uplink reception power TURP is set regardless of the offset value OV, interference caused by the user device 300 can be curbed.

### Second Embodiment

A second embodiment according to the present invention is described below. In each embodiment described below, for elements for which operation and function are equivalent to those in the first embodiment, the reference symbols used in the above description are used, and description thereof is omitted as appropriate.

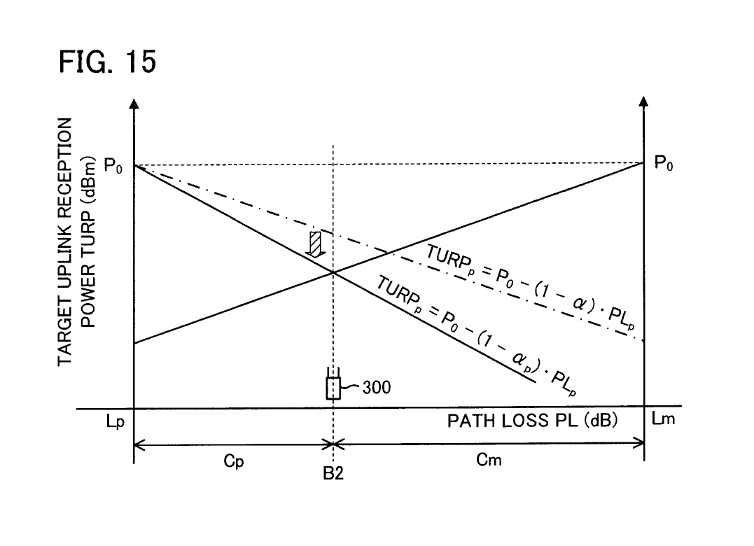

In the second embodiment, the path loss correction coefficient α, a parameter used to calculate the target uplink reception power TURP at the pico base station 200, is set (changed) according to the offset value OV used for the cell range expansion. With reference to FIGS. 14 and 15, explanation is provided below. In FIGS. 14 and 15, the user device 300 is assumed to be connected wirelessly to the pico base station 200.

FIG. 14 illustrates a case in which the offset value OV is relatively low. The parameter setting unit 142 of the macro base station 100 sets the path loss correction coefficient α according to the offset value OV provided by the offset value setting unit 132. Since the offset value OV is relatively low and the cell boundary B1 is close to the pico base station 200 in FIG. 14, the difference between the path loss PLₚ and the path loss PLₘ at the cell boundary B1 is large. The parameter setting unit 142, therefore, sets the path loss correction coefficient αₚ at the pico base station 200 relatively low (i.e., sets the slope−(1−αₚ) relatively large).

On the other hand, FIG. 15 illustrates a case in which the offset value OV is relatively high. In FIG. 15, compared with FIG. 14, the cell boundary B2 is close to the macro base station 100, and thus, the difference between the path loss PLₚ and the path loss PLₘ at the cell boundary B2 is small. The parameter setting unit 142, therefore, sets the path loss correction coefficient αₚ at the pico base station 200 relatively high (i.e., sets the slope−(1−αₚ) relatively small).

As described above, as the offset value OV decreases, the parameter setting unit 142 sets the path loss correction coefficient αₚ at the pico base station 200 lower to a greater extent than the path loss correction coefficient αₘ at the macro base station 100 (i.e., the lower the offset value OV, the greater the slope−(1−αₚ)). The path loss correction coefficient αₚ set by the parameter setting unit 142 is provided to the parameter notifying unit 144. Additionally, the standard uplink reception power P₀ that is not set based on the offset value OV is provided to the parameter notifying unit 144. The parameter notifying unit 144 reports, through the network communication unit 120, the parameters (the standard uplink reception power P₀ and the path loss correction coefficient αₚ) to the parameter receiving unit 246 of the pico base station 200.

The target uplink reception characteristic calculating unit 248 of the pico base station 200 calculates the target uplink reception power TURPₚ from the user device 300 at the pico base station 200. Specifically, using the path loss PLₚ between the pico base station 200 and the user device 300 that is calculated by the path loss calculating unit 242 and the standard uplink reception power P₀ and the path loss correction coefficient αₚ that are provided by the parameter receiving unit 246, the target uplink reception characteristic calculating unit 248 calculates the target uplink reception power TURP based on Formula (2) below.

TURPₚ=P₀−(1−αₚ)·PLₚ Formula (2)

With regard to the user device 300 located at the cell boundary B, it is even more preferable if the path loss correction coefficient αₚ is set so that the target uplink reception power TURPₚ at the pico base station 200 matches the target uplink reception power TURPₘ at the macro base station 100.

In the above configuration, since the path loss correction coefficient α at the pico base station 200 is set according to the offset value OV used for the cell range expansion, the difference between the target uplink reception power TURPₘ at the macro base station 100 from the user device 300 located close to the cell boundary B and the target uplink reception power TURPₚ at the pico base station 200 from the user device 300 located close to the cell boundary B is reduced. As a result, the difference in uplink transmission powers from the user device 300 to the base stations (the macro base station 100, the pico base station 200) is also reduced. Therefore, compared with a configuration in which the target uplink reception power TURP is set regardless of the offset value OV, interference caused by the user device 300 can be curbed.

### Third Embodiment

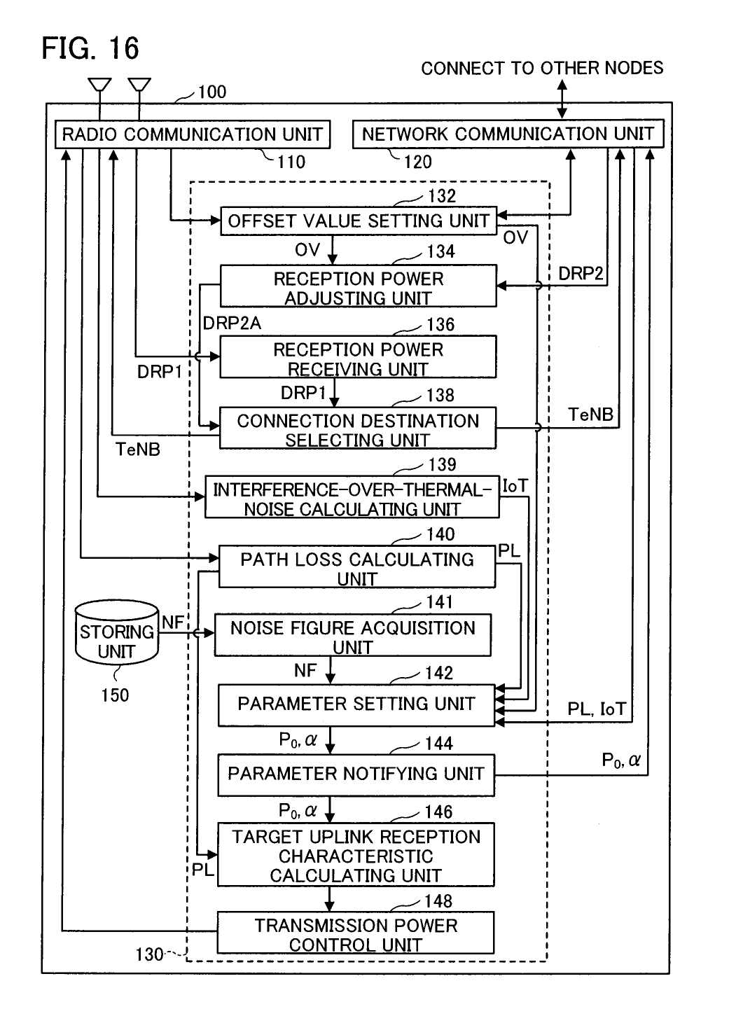

FIG. 16 is a block diagram illustrating a configuration of a macro base station 100 according to a third embodiment. The macro base station 100 according to the third embodiment further includes a storing unit 150 that stores a noise figure NFₘ of the macro base station 100 and a noise figure NFₚ of the pico base station 200. A noise figure NF represents a ratio of input signal quality (e.g., input signal to noise ratio) and output signal quality (output signal to noise ratio) at a base station. Generally, the noise figure NFₘ of the macro base station 100 is lower than the noise figure NFₚ of the pico base station 200. That is, noises are less likely to be generated at the macro base station 100 than at the pico base station 200.

The control unit 130 of the macro base station 100 according to the third embodiment further includes an interference-over-thermal-noise calculating unit 139 configured to calculate an interference over thermal noise IoTₘ at the macro base station 100 and a noise figure acquisition unit 141 configured to acquire the noise figure NF from the storing unit 150. The interference over thermal noise IoT is calculated using Formula (3) below. In Formula (3), I represents interference that a base station receives (interference from a user device 300 connected to another base station) and N represents thermal noise of the base station. An average value of interference over thermal noises IoT over a given period of time may be used as the interference over thermal noise IoT.

IoT=(I+N)/N Formula (3)

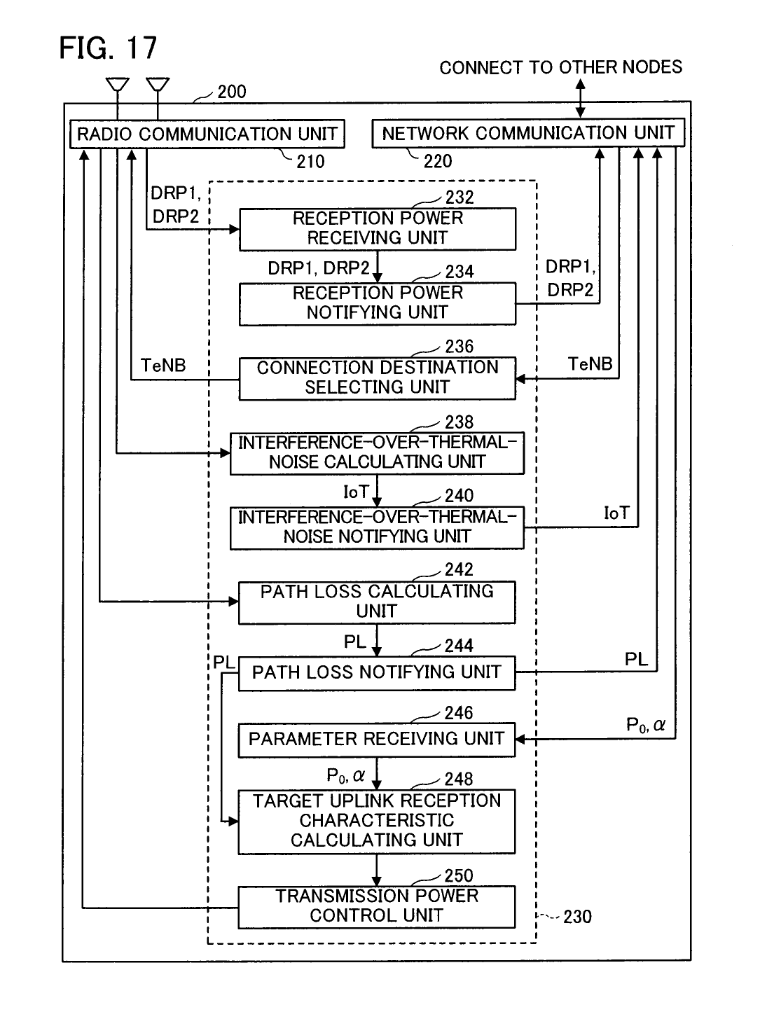

FIG. 17 is a block diagram illustrating a configuration of a pico base station 200 according to the third embodiment. The control unit 230 of the pico base station 200 according to the third embodiment further includes an interference-over-thermal-noise calculating unit 238 configured to calculate an interference over thermal noise IoTₚ at the pico base station 200, an interference-over-thermal-noise notifying unit 240 configured to report the interference over thermal noise IoTₚ to the macro base station 100, and a path loss notifying unit 244 configured to report the path loss PLₚ to the macro base station 100. A formula to calculate the interference over thermal noise IoTₚ is as described above.

When the offset value OV is low (when the range of the picocell Cp is small), the interference over thermal noise IoTₚ of the pico base station 200 is higher than the interference over thermal noise IoTₘ of the macro base station 100, because the user device 300 that is located close to the pico base station 200 and is connected to the macro base station 100 severely interferes with the pico base station 200. On the other hand, when the offset value OV is high (the range of the picocell Cp is large), the interference over thermal noise IoTₘ of the macro base station 100 is higher than the interference over thermal noise IoTₚ of the pico base station 200, because the user device 300 that is located close to the macro base station 100 and is connected to the pico base station 200 severely interferes with the macro base station 100. As it is understood from the description above, an interference over thermal noise IoT is a value that changes according to the offset value OV.

As in the first embodiment (FIGS. 12 and 13) and the second embodiment (FIGS. 14 and 15), the user device 300 is assumed to be located close to the cell boundary B.

For the macro base station 100, based on the interference over thermal noise IoTₘ provided by the interference-over-thermal-noise calculating unit 139, the path loss PLₘ provided by the path loss calculating unit 140, and the noise figure NFₘ provided by the noise figure acquisition unit 141, the parameter setting unit 142 of the macro base station 100 calculates a temporary target uplink reception quality TUSINRₘ at the macro base station 100. For the pico base station 200, based on the interference over thermal noise IoTₚ provided by the interference-over-thermal-noise notifying unit 240, the path loss PLₚ provided by the path loss notifying unit 244, and the noise figure NFₚ provided by the noise figure acquisition unit 141, the parameter setting unit 142 of the macro base station 100 calculates a temporary target uplink reception quality TUSINRₚ at the pico base station 200. A target uplink reception quality TUSINR is calculated using Formula (4) below. For the standard uplink reception power P₀ and the path loss correction coefficient α that are used to calculate a temporary target uplink reception quality TUSINR, values that are currently in use or predetermined default values can be used.

TUSINR=(P₀−(1−α)·PL)/(IoT+NF) Formula (4)

Subsequently, the parameter setting unit 142 sets at least one of the standard uplink reception power P₀ and the path loss correction coefficient α so that the temporary target uplink reception quality TUSINRₚ approaches the temporary target uplink reception quality TUSINRₘ (i.e., so that the difference between the two values is reduced). For example, when the relationship TUSINRₚ>TUSINRₘ is established, in order to lower the temporary target uplink reception quality TUSINRₚ, the parameter setting unit 142 sets the standard uplink reception power P₀ and the path loss correction coefficient α at the pico base station 200 so that at least one of them decreases. The parameter setting unit 142 can also set parameters so that the temporary target uplink reception quality TUSINRₘ increases.

Preferably, the parameter setting unit 142 sets at least one of the standard uplink reception power P₀ and the path loss correction coefficient α so that the difference between the target uplink reception quality TUSINRₚ and the target uplink reception quality TUSINRₘ be less than a threshold Th. Even more preferably, the parameter setting unit 142 sets at least one of the standard uplink reception power P₀ and the path loss correction coefficient α so that the target uplink reception quality TUSINRₚ matches the target uplink reception quality TUSINRₘ. For a parameter that is not set based on the target uplink reception quality TUSINR, a value that is currently in use or a predetermined default value can be set.

The parameters (the standard uplink reception power P₀ and the path loss correction coefficient α) set by the parameter setting unit 142 are provided to the parameter notifying unit 144. The parameters for the macro base station 100 are reported to the target uplink reception characteristic calculating unit 146 by the parameter notifying unit 144 so as to be used to calculate the target uplink reception quality TUSINRₘ at the macro base station 100. The parameters for the pico base station 200 are reported to the pico base station 200 (the parameter receiving unit 246) through the network communication unit 120 and are provided by the parameter receiving unit 246 to the target uplink reception characteristic calculating unit 248 so as to be used to calculate the target uplink reception quality TUSINRₚ at the pico base station 200. The target uplink reception qualities TUSINR are calculated based on Formula (4) stated above.

According to the above configuration, the uplink transmission power of the user device 300 is controlled based on the target uplink reception quality TUSINR. Therefore, compared with a configuration in which the uplink transmission power of the user device 300 is controlled based on the target uplink reception power TURP, the uplink transmission power can be controlled in a manner in which interference that the base stations receive and noises of the base stations are taken into consideration.

### MODIFICATIONS

The embodiments described above can be modified in various ways. Examples of modifications are described below. Two or more of the modifications can be combined as appropriate, provided that the combined modifications do not conflict with each other.

### (1) Modification 1

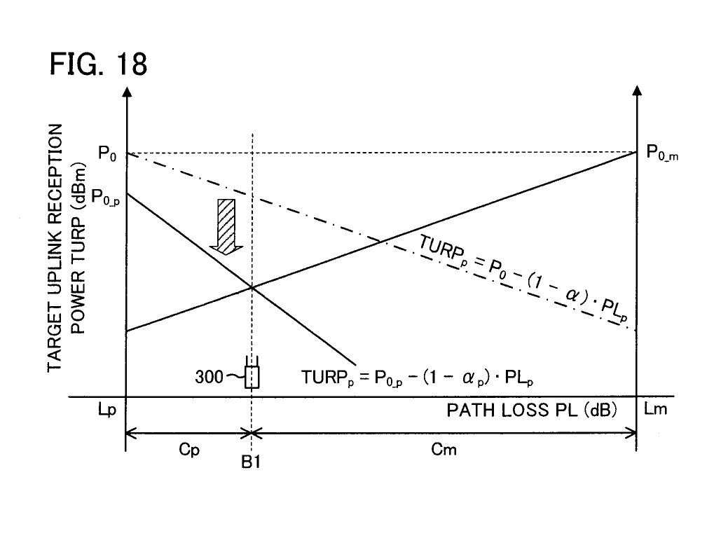

The standard uplink reception power P₀ set as in the first embodiment and the path loss correction coefficient α set as in the second embodiment can be combined. That is, as shown in FIG. 18, as the offset value OV decreases, the parameter setting unit 142 can set the standard uplink reception power P₀_{_{—}}ₚ at the pico base station 200 lower to a greater extent than the standard uplink reception power P₀_{_{—}}ₘ at the macro base station 100 (i.e., set the standard uplink reception power P₀_{_{—}}ₚ at the pico base station 200 lower than the standard uplink reception power P₀ before modification). Additionally, as the offset value OV decreases, the parameter setting unit 142 can set the path loss correction coefficient αₚ at the pico base station 200 lower to a greater extent than the path loss correction coefficient αₘ at the macro base station 100 (i.e., set the path loss correction coefficient αₚ at the pico base station 200 lower than the path loss correction coefficient α).

### (2) Modification 2

In the above embodiments, information (the offset value OV, the path loss PL, the interference over thermal noise IoT, etc.) is collected at the parameter setting unit 142 of the macro base station 100 and the parameters (the standard uplink reception power P₀, the path loss correction coefficient α) are calculated. However, the information may be collected at the pico base station 200 and the parameters may be calculated at the pico base station 200. When the parameters are calculated at the pico base station 200, the parameters related to the macro base station 100 are reported to the macro base station 100 through the network communication unit 220 of the pico base station 200.

### (3) Modification 3

In the above embodiments, the pico base station 200 is used as an example of a base station with lower transmission capacity than the macro base station 100. However, a base station such as a micro base station, a nano base station, a femto base station, and a remote radio head may be used as a base station with a low transmission capacity. In particular, as components of the radio communication system 1, a combination of base stations with varying transmission capacities (e.g., a combination of a macro base station, a pico base station, and a femto base station) may be used.

### (4) Modification 4

In the above embodiments, based on the downlink reception power DRP reported by the user device 300, the macro base station 100 (the connection destination selecting unit 138) selects a connection destination for the user device 300. However, a connection destination selecting unit may be included in the pico base station 200 or in the user device 300. Similarly, a reception power adjusting unit may be included in the pico base station 200 or in the user device 300. That is, the selection of a connection destination base station according to the present invention is characterized in that a connection destination is selected based on downlink reception power DRP 1 from the macro base station 100 and adjusted downlink reception power DRP2 from the pico base station 200. The adjustment with the offset value OV and the selection of a connection destination base station can be carried out at a freely chosen device.

### (5) Modification 5

A user device 300 is a freely chosen device capable of communicating wirelessly with each base station (macro base station 100, pico base station 200). The user device 300 may be a mobile phone terminal such as a feature phone or a smartphone, a desktop personal computer, a laptop personal computer, an ultra-mobile personal computer (UMPC), a portable game console, or any other type of wireless terminal.

### (6) Modification 6

Functions executed by a CPU at each of the components (the macro base station 100, the pico base station 200, the user device 300) in the radio communication system 1 may be executed by a piece of hardware instead of by a CPU, or by a programmable logic device such as a field programmable gate array (FPGA) and a digital signal processor (DSP).

### REFERENCE SYMBOLS

1: Radio Communication System
100: Macro Base Station
110: Radio Communication Unit
120: Network Communication Unit
130: Control Unit
132: Offset Value Setting Unit
134: Reception Power Adjusting Unit
136: Reception Power Receiving Unit
138: Connection Destination Selecting Unit
139: Interference-over-Thermal-Noise Calculating Unit
140: Path Loss Calculating Unit
141: Noise Figure Acquisition Unit
142: Parameter Setting Unit
144: Parameter Notifying Unit
146: Reception Characteristic Calculating Unit
148: Transmission Power Control Unit
150: Storing Unit
200: Pico Base Station
210: Radio Communication Unit
220: Network Communication Unit
230: Control Unit
232: Reception Power Receiving Unit
234: Reception Power Notifying Unit
236: Connection Destination Selecting Unit
238: Interference-over-Thermal-Noise Calculating Unit
240: Interference-over-Thermal-Noise Notifying Unit
242: Path Loss Calculating Unit
244: Path Loss Notifying Unit
246: Parameter Receiving Unit
248: Reception Characteristic Calculating Unit
250: Transmission Power Control Unit
300: User Device
310: Radio Communication Unit
330: Control Unit
332: Reception Power Measuring Unit
334: Reception Power Reporting Unit
336: Communication Control Unit
α (αₘ, αₚ): Path Loss Correction Coefficient
B (B1, B2): Cell Boundary
C (Cm, Cp): Cell
DRP (DRP1, DRP2, DRP2A): Downlink Reception Power
IoT (IoTₘ, IoTₚ): Interference over Thermal Noise
L (L1 to L3, Lm, Lp, Lu): Location
NF (NFₘ, NFₚ): Noise Figure
OV: Offset Value
P₀ (P₀_{_{—}}ₘ, P₀_{_{—}}ₚ₎: Standard Uplink Reception Power
PL (PLₘ, PLₚ): Path Loss
RG1: Range
TURP (TURPₘ, TURPₚ): Target Uplink Reception Power
TUSINR (TUSINRₘ, TUSINRₚ): Target Uplink Reception Quality
TeNB: Connection Destination Base Station Information.

1. A radio communication system comprising:
base stations comprising a first base station that forms a first cell and a second base station that forms a second cell that is smaller in area than the first cell;
a user device configured to communicate wirelessly with each of the base stations by transmitting and receiving radio waves;
a downlink reception power adjusting unit configured to adjust downlink reception power from the second base station at the user device upward using a cell range expansion offset value corresponding to the second base station;
a connection destination selecting unit configured to select, based on downlink reception power from the first base station and the downlink reception power from the second base station that has been adjusted with the cell range expansion offset value, a connection destination base station for the user device;
a target uplink reception characteristic calculating unit configured to calculate a target uplink reception characteristic of radio waves from the user device at at least one base station that is comprised in the base stations;
a parameter setting unit configured to set, according to the cell range expansion offset value corresponding to the second base station, a parameter for calculating a target uplink reception characteristic at the second base station; and
a transmission power control unit configured to control uplink transmission power of the user device so that an uplink reception characteristic of radio waves from the user device at the at least one base station approaches the target uplink reception characteristic.

2. The radio communication system according to claim 1, comprising:
a path loss calculating unit configured to calculate path loss between the at least one base station and the user device,
wherein the target uplink reception characteristic calculating unit calculates, as the target uplink reception characteristic, target uplink reception power from the user device at the at least one base station based on a following formula
TURP=P₀−(1−α)·PL
where TURP represents the target uplink reception power, P₀ represents standard uplink reception power, α represents a path loss correction coefficient, and PL represents the path loss,
wherein the parameter setting unit sets, according to the cell range expansion offset value corresponding to the second base station, at least one of the standard uplink reception power and the path loss correction coefficient, each of which is a parameter for calculating target uplink reception power at the second base station, and
wherein the transmission power control unit controls uplink transmission power of the user device so that uplink reception power from the user device at the at least one base station approaches the target uplink reception power.

3. The radio communication system according to claim 1, comprising:
a path loss calculating unit configured to calculate path loss between the at least one base station and the user device;
an interference-over-thermal-noise calculating unit configured to calculate an interference over thermal noise at the at least one base station; and
a noise figure acquisition unit configured to acquire a noise figure that represents a ratio of input signal quality and output signal quality at the at least one base station,
wherein the target uplink reception characteristic calculating unit calculates, as the target uplink reception characteristic, a target uplink reception quality of radio waves from the user device at the at least one base station based on a following formula
TUSINR=(P₀−(1−α)·PL)/(IoT+NF)
where TUSINR represents the target uplink reception quality, P₀ represents standard uplink reception power, α represents a path loss correction coefficient, PL represents the path loss, IoT represents the interference over thermal noise, and NF represents the noise figure,
wherein the parameter setting unit sets, for the user device at which downlink reception power from the first base station is equal to the downlink reception power from the second base station that has been adjusted with the cell range expansion offset value, at least one of the standard uplink reception power and the path loss correction coefficient, each of which is a parameter for calculating a target uplink reception quality at the second base station, so that a difference between a target uplink reception quality at the first base station and the target uplink reception quality at the second base station is reduced,
wherein the transmission power control unit controls uplink transmission power of the user device so that an uplink reception quality of radio waves from the user device at the at least one base station approaches the target uplink reception quality.

4. The radio communication system according to claim 3,
wherein the second base station comprises:
an interference-over-thermal-noise notifying unit configured to report an interference over thermal noise calculated by the interference-over-thermal-noise calculating unit of the second base station to the first base station,
wherein the parameter setting unit of the first base station sets, based on an interference over thermal noise calculated by the interference-over-thermal-noise calculating unit of the first base station and the interference over thermal noise reported by the interference-over-thermal-noise notifying unit of the second base station, at least one of the standard uplink reception power and the path loss correction coefficient at the first base station and at least one of the standard uplink reception power and the path loss correction coefficient at the second base station, and
wherein the first base station comprises:
a parameter notifying unit configured to report, to the second base station, the at least one of the standard uplink reception power and the path loss correction coefficient at the second base station that has been set by the parameter setting unit of the first base station.

5. The radio communication system according to claim 2,
wherein the parameter setting unit sets, as the cell range expansion offset value decreases, the standard uplink reception power at the second base station lower to a greater extent than the standard uplink reception power at the first base station.

6. The radio communication system according to claim 2,
wherein the parameter setting unit sets, as the cell range expansion offset value decreases, the path loss correction coefficient at the second base station lower to a greater extent than the path loss correction coefficient at the first base station.

7. The radio communication system according to claim 2,
wherein the parameter setting unit, as the cell range expansion offset value decreases, sets the standard uplink reception power at the second base station lower to a greater extent than the standard uplink reception power at the first base station and sets the path loss correction coefficient at the second base station lower to a greater extent than the path loss correction coefficient at the first base station.

8. A base station in a radio communication system,
the radio communication system comprising:
base stations comprising a first base station that forms a first cell and a second base station that forms a second cell that is smaller in area than the first cell; and
a user device configured to communicate wirelessly with each of the base stations by transmitting and receiving radio waves,
the base station being the first base station in the radio communication system,
the base station comprising:
a downlink reception power adjusting unit configured to adjust downlink reception power from the second base station at the user device upward using a cell range expansion offset value corresponding to the second base station;
a connection destination selecting unit configured to select, based on downlink reception power from its own station and the downlink reception power from the second base station that has been adjusted with the cell range expansion offset value, a connection destination base station for the user device;
a target uplink reception characteristic calculating unit configured to calculate a target uplink reception characteristic of radio waves from the user device at at least one base station comprised in the base stations;
a parameter setting unit configured to set, according to the cell range expansion offset value corresponding to the second base station, a parameter for calculating a target uplink reception characteristic at the second base station;
a parameter notifying unit configured to report the parameter set by the parameter setting unit to the second base station; and
a transmission power control unit configured to control uplink transmission power of the user device so that, at the at least one base station, an uplink reception characteristic of radio waves from the user device approaches the target uplink reception characteristic.

9. The base station according to claim 8, comprising:
a path loss calculating unit configured to calculate path loss between the at least one base station and the user device,
wherein the target uplink reception characteristic calculating unit calculates, as the target uplink reception characteristic, target uplink reception power from the user device at the at least one base station based on a following formula
TURP=P₀−(1−α)·PL
where TURP represents the target uplink reception power, P₀ represents standard uplink reception power, α represents a path loss correction coefficient, and PL represents the path loss,
wherein the parameter setting unit sets, according to the cell range expansion offset value corresponding to the second base station, at least one of the standard uplink reception power and the path loss correction coefficient, each of which is a parameter for calculating target uplink reception power at the second base station, and
wherein the transmission power control unit controls uplink transmission power of the user device so that uplink reception power from the user device at the at least one base station approaches the target uplink reception power.

10. The base station according to claim 8, comprising:
a path loss calculating unit configured to calculate path loss between the at least one base station and the user device;
an interference-over-thermal-noise calculating unit configured to calculate an interference over thermal noise at the at least one base station; and
a noise figure acquisition unit configured to acquire a noise figure that represents a ratio of input signal quality and output signal quality at the at least one base station,
wherein the target uplink reception characteristic calculating unit calculates, as the target uplink reception characteristic, a target uplink reception quality of radio waves from the user device at the at least one base station based on a following formula
TUSINR=(P₀−(1−α)·PL)/(IoT+NF)
where TUSINR represents the target uplink reception quality, P₀ represents standard uplink reception power, α represents a path loss correction coefficient, PL represents the path loss, IoT represents the interference over thermal noise, and NF represents the noise figure,
wherein the parameter setting unit sets, for the user device at which downlink reception power from its own station is equal to the downlink reception power from the second base station that has been adjusted with the cell range expansion offset value, at least one of the standard uplink reception power and the path loss correction coefficient, each of which is a parameter for calculating a target uplink reception quality at the second base station, so that a difference between a target uplink reception quality at its own station and the target uplink reception quality at the second base station is reduced, and
wherein the transmission power control unit controls uplink transmission power of the user device so that, at the at least one base station, an uplink reception quality of radio waves from the user device approaches the target uplink reception quality.

11. The base station according to claim 10, comprising:
a receiving unit configured to receive an interference over thermal noise at the second base station reported by the second base station,
wherein the parameter setting unit of the first base station sets, based on an interference over thermal noise calculated by the interference-over-thermal-noise calculating unit of the first base station and the interference over thermal noise reported by the interference-over-thermal-noise notifying unit of the second base station, at least one of the standard uplink reception power and the path loss correction coefficient at the first base station and at least one of the standard uplink reception power and the path loss correction coefficient at the second base station, and
wherein the parameter notifying unit reports, to the second base station, the at least one of the standard uplink reception power and the path loss correction coefficient at the second base station that has been set by the parameter setting unit.

12. A communication control method for a radio communication system, the radio communication system comprising:
base stations comprising a first base station that forms a first cell and a second base station that forms a second cell that is smaller in area than the first cell; and
a user device configured to communicate wirelessly with each of the base stations by transmitting and receiving radio waves,
the communication control method comprising:
adjusting downlink reception power from the second base station at the user device upward using a cell range expansion offset value corresponding to the second base station;
selecting, based on downlink reception power from the first base station and the downlink reception power from the second base station that has been adjusted with the cell range expansion offset value, a connection destination base station for the user device;
calculating a target uplink reception characteristic of radio waves from the user device at at least one base station that is comprised in the base stations;
setting, according to the cell range expansion offset value corresponding to the second base station, a parameter for calculating a target uplink reception characteristic at the second base station; and
controlling uplink transmission power of the user device so that, at the at least one base station, an uplink reception characteristic of radio waves from the user device approaches the target uplink reception characteristic.

13. The communication control method according to claim 12, comprising:
calculating path loss between the at least one base station and the user device;
in the calculating of the target uplink reception characteristic, as the target uplink reception characteristic, target uplink reception power from the user device at the at least one base station is calculated based on a following formula
TURP=P₀−(1−α)·PL
where TURP represents the target uplink reception power, P₀ represents standard uplink reception power, α represents a path loss correction coefficient, and PL represents the path loss;
in the setting of the parameter, according to the cell range expansion offset value corresponding to the second base station, at least one of the standard uplink reception power and the path loss correction coefficient, each of which is a parameter for calculating target uplink reception power at the second base station, is set; and
in the controlling of the transmission power, uplink transmission power of the user device is controlled so that, at the at least one base station, uplink reception power from the user device approaches the target uplink reception power.

14. The communication control method according to claim 12, comprising:
calculating path loss between the at least one base station and the user device;
calculating an interference over thermal noise at the at least one base station;
acquiring a noise figure that represents a ratio of input signal quality and output signal quality at the at least one base station;
in the calculating of the target uplink reception characteristic, as the target uplink reception characteristic, a target uplink reception quality of radio waves from the user device at the at least one base station is calculated based on a following formula
TUSINR=(P₀−(1−α)·PL)/(IoT+NF)
where TUSINR represents the target uplink reception quality, P₀ represents standard uplink reception power, α represents a path loss correction coefficient, PL represents the path loss, IoT represents the interference over thermal noise, and NF represents the noise figure;
in the setting of the parameter, for the user device at which downlink reception power from the first base station is equal to the downlink reception power from the second base station that has been adjusted with the cell range expansion offset value, at least one of the standard uplink reception power and the path loss correction coefficient, each of which is a parameter for calculating a target uplink reception quality at the second base station, is set so that a difference between a target uplink reception quality at the first base station and the target uplink reception quality at the second base station is reduced; and
in the controlling of the transmission power, uplink transmission power of the user device is controlled so that, at the at least one base station, an uplink reception quality of radio waves from the user device approaches the target uplink reception quality.
